(19) United States
(12) Patent Application Publication
(10) Pub. No.: US 2008/0047448 A1
(43) Pub. Date: Feb. 28, 2008

(54) Printing device and method

(76) Inventors: Thomas G Cocklin, Vancouver, WA (US); Michael D. Kwan, Vancouver, WA (US); Richard A. Kelly, Vancouver, WA (US); Jon Johnson, Vancouver, WA (US); Neil Clark, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/510,953

(22) Filed: Aug. 28, 2006

(51) Int. Cl. G03G 15/00

(52) U.S. Cl. 101/483

(57) ABSTRACT

A method for assisting a user to clear a media jam in a printing device, that provides text-based instructions responsively to detecting the media jam; provides video-based instructions responsively to detecting the media jam; and, activates visual indicators corresponding to select parts of the printing device responsively to the detected media jam; wherein the text based instructions, video-based instructions and activating each communicate a common resolution procedure for the detected media jam.

### FIELD OF THE INVENTION

The present invention relates to printing devices and methods. More particularly, the present invention relates to printing devices having media jam indicators and to methods for resolving printable media jams.

### BACKGROUND OF THE INVENTION

Printable media jams, or jams, occur in printing devices or printers, such as laser printers, ink-jet printers, impact printers, facsimile machines, photocopiers and combination devices having printing capabilities. Jams often prove difficult to find and remedy, as jams may occur at various locations along a printable media path of the printing devices. The printable media typically takes the form of printable substrates, such as paper or plastic substrates. Approaches to dealing with a jam typically only advise that a jam has occurred. In some cases, the printer will provide a single indication of a general area of the media jam. In other instances, detailed instructions for locating and clearing areas where jams typically occur may be disposed on the inside front door of the printing device, or may be included in a user's guide or on-line manual. Alternative mechanisms for enabling a user to locate and resolve media jams are desired.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts and:

FIG. 1 shows a perspective view of a printing device according to an embodiment of the present invention;

FIG. 2 shows a plan view of a media path corresponding to the printing device of FIG. 1 according to an embodiment of the present invention;

FIGS. 3a and 3b show a perspective view of the printing device of FIG. 1 indicating a media jam at one location in the media path according to an embodiment of the present invention;

FIG. 3c shows a view of a lower-side door of the printing device of FIG. 1 according to an embodiment of the present invention;

FIG. 4a shows a perspective view of the printing device of FIG. 1 indicating a media jam at another location in the media path according to an embodiment of the present invention;

FIG. 4b shows a perspective view of the printing device of FIG. 4a indicating a next successive step necessary to locate the media jam according to an embodiment of the present invention;

FIG. 4c shows a perspective, exploded view of the printing device of FIG. 4b indicating the location of the media jam according to an embodiment of the present invention;

FIG. 5 shows a block diagram of a system suitable for use with the printing device of FIG. 1 according to an embodiment of the present invention;

FIG. 6 shows a view of a screen suitable for being displayed on the printing device of FIG. 1 according to an embodiment of the present invention;

FIG. 7 shows a perspective view of a printing device sounding an audible indicator according to an embodiment of the present invention; and

FIG. 8 shows a block diagram of a process according to an embodiment of the present invention.

### DETAILED DESCRIPTION OF THE PREFERRED EMBODIMENTS

The following description of the preferred embodiments is merely by way of example and is in no way intended to limit the invention, its application, or uses.

Different people respond in different ways to different types of instruction (e.g., spatial instruction, visual instruction and linguistic instruction). These understandings may be applied to assist users to resolve media jams in printing devices. By way of explanation, people who are generally classified as spatial learners learn by doing, or based upon manipulations of objects in their three-dimensional world. Spatial memory is responsible for recording information about one's environment and its spatial orientation. For example, a person's spatial memory is used to navigate around a familiar city. People who are generally classified as visual learners learn by seeing. For visual learners, pictures represent significant cues in the learning experience. Visual learners benefit from viewing static or dynamic pictures that are two-dimensional in nature. And, people who are classified as linguistic learners learn by reading and interacting with text or symbols that have a grammar and lexicon. Thus, some people learn best from spatial experience or instructions, other people learn best from visual instruction, and still others learn best from linguistic instruction.

According to an embodiment of the present invention these understandings may be utilized to comprehensively assist all three types of users to resolve media jams in printing devices. For example, a combination of visual instruction, linguistic instruction, and spatial indications may be used to assist a user to resolve media jams in printing devices.

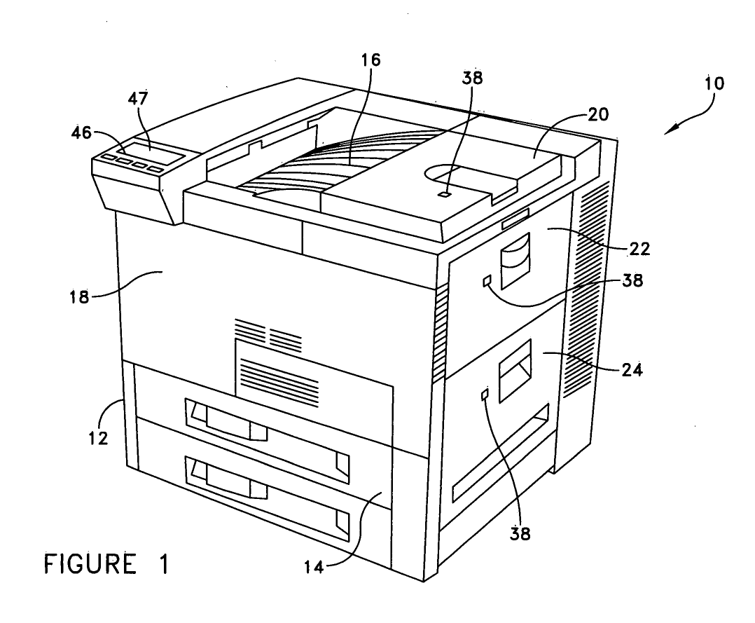

FIG. 1 shows a perspective view of an exemplary printing device 10 in accordance with one embodiment of the present invention. The illustrated printing device 10 takes the form of a printer, and will be referred to thereas for discussion purposes only. The illustrated printer 10 is a laser type printer. It will be appreciated however, that other types of printers and printing devices, such as an inkjet printer, a large format printer, copier or a combination printer, scanner, copier, fax or the like, may similarly be realized.

Printer 10 includes a housing 12. Printer 10 also includes at least one feed tray 14, from where the media to be printed, e.g., printable media, is stored and fed into the printer 10. In the illustrated case, the media takes the form of sheets of paper. But other media, such as transparencies, envelopes, post cards, photo media and the like, may also be used.

Printer 10 includes an output tray 16 for receiving the printed media. Printer 10 also includes one or more access doors 18, 20, 22, 24. The embodiment of FIG. 1 shows four access doors 18, 20, 22, 24, but other numbers of doors may be used. In the illustrated embodiment front access door 18 provides access to the interior of the front area of the housing 12. In the illustrated embodiment, top access door 20 allows access to the top area of the housing 12. In the illustrated embodiment, upper and lower side access doors 22, 24 allow access to different areas within the housing 12 near a side thereof.

Printer 10 includes a user interface 46. While the illustrated user interface 46 includes four (4) buttons and a display 47, other configurations can be used.

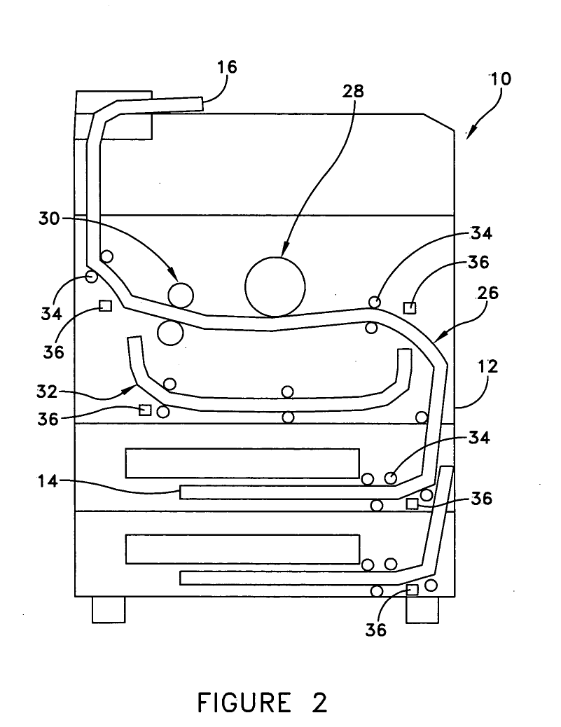

Referring now also to FIG. 2, it shows a plan view of an exemplary media path 26 for moving printable media through printer 10 in accordance with an embodiment of the present invention. In the illustrated case, printable media moves from tray 14 and through housing 12 along a paper path generally indicated at 26. The media travels to a drum unit 28, where toner is applied to it. The media then travels to a fuser assembly 30, where the applied toner is fused to the media. Thereafter, the media moves to output tray 16. A duplexing path 32, which is an alternative media path, allows for printing two opposing sides or surfaces of the media.

Where ink-jet technology is used in lieu of laser printing technology, housing 12 will incorporate ink and one or more dryers, as opposed to toner and one or more fusers.

Rollers 34 move the media along or through media path 26. One or more of the rollers 34 may be coupled to a drive motor (not shown) to impart movement thereto. As the media travels along media path 26 it may become jammed. Jams are detected by printable media jam sensors 36 associated with media path 26. Any suitable number of and type of jam sensor can be used within the context of the illustrated embodiment.

Once a jam is detected, a series of sequential indications are provided to assist a user to resolve the jam. According to an embodiment of the present invention a plurality of indications of differing types is provided in accordance with a same resolution sequence. According to an embodiment of the present invention, a sequence of spatial indications, a sequence of visual instructions and a sequence of linguistic instructions are provided to assist a user to resolve one or more media jams along the media path.

### Spatial Indicators

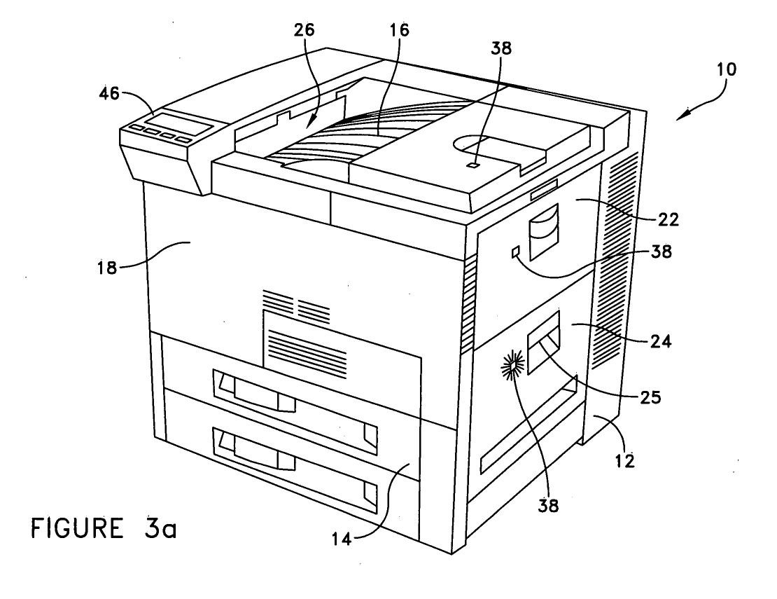

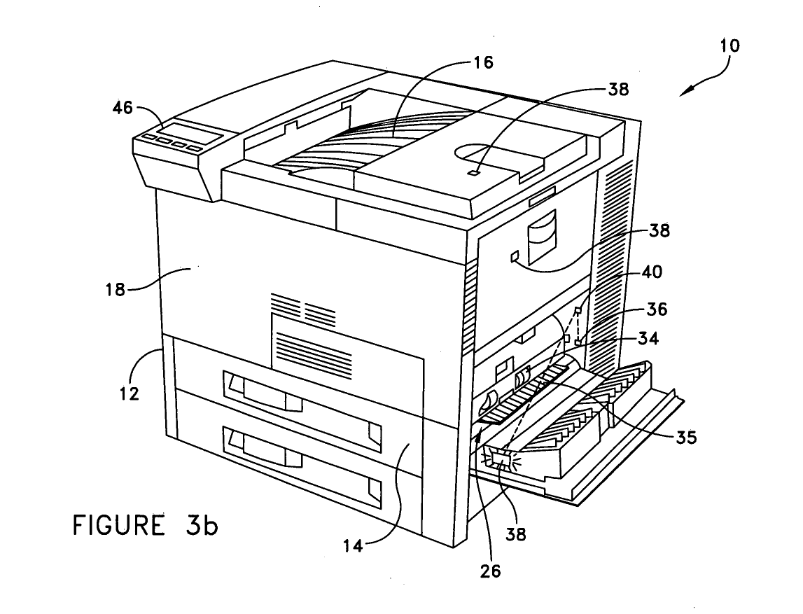

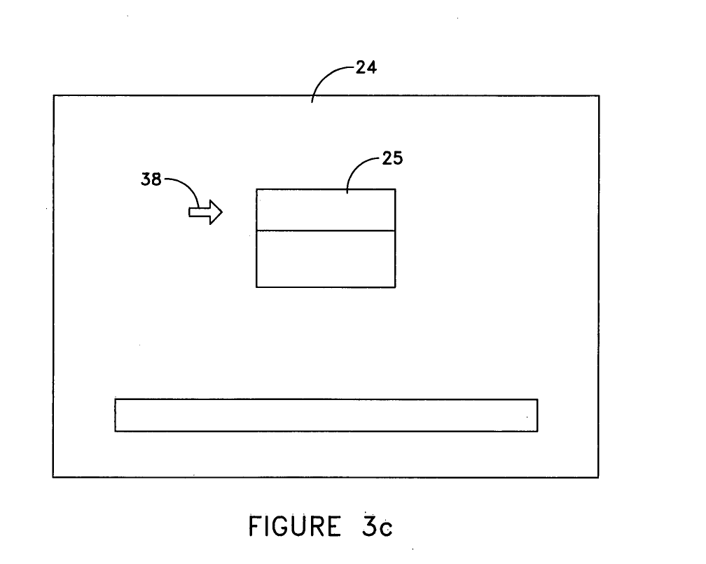

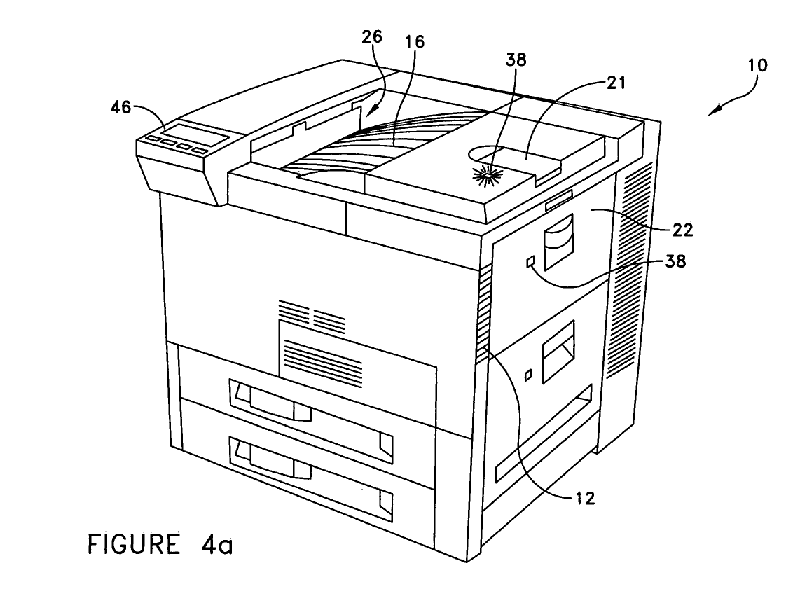

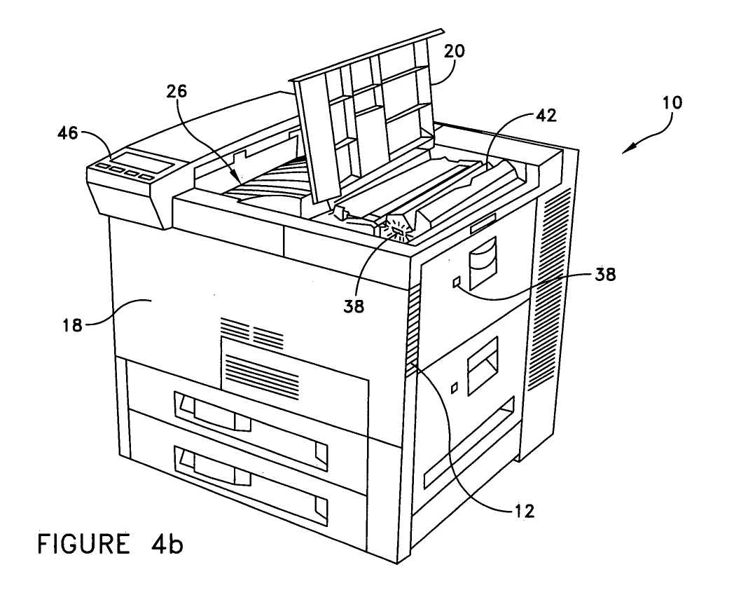

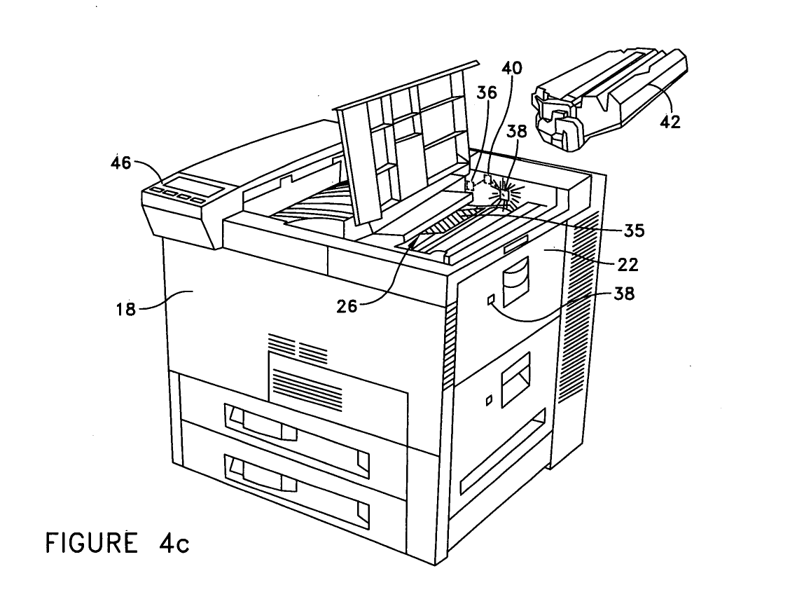

FIGS. 3A and 3B show perspective views of the printer 10 of FIG. 1 indicating a media jam at one location in the media path. FIGS. 4A and 4B show perspective views of the printer 10 of FIG. 1 indicating a media jam at another location in the media path. Referring now to FIGS. 1-4B, printer 10 includes a plurality of spatial indicators 38. Each spatial indicator may selectively emit light. According to an embodiment of the present invention, each spatial indicator 38 may take the form of one or more light emitting diodes (LED's). Spatial indicators 38 can take other forms of visible indicators as well, such as a different kind of light emitting device, a mechanical tab that may be selectively positioned, or any other selectively activated indicator. Spatial indicators 38 provide spatial indications to assist users to resolve media jams detected by one or more of the sensors 36.

Spatial indicators 38 can be located adjacent to a printer component adapted to be manipulated by a user, such as a door latch 25 (FIG. 3A) or lever. Additionally, or in lieu thereof, spatial indicators 38 can be located adjacent media path 26. For example, indicators 38 may be positioned along media path 26. Referring now also to FIG. 3C, there is shown a view of lower side door 24 of printer 10. Spatial indicator 38 takes the form of a selectively illuminated arrow. According to an embodiment of the present invention, one or more of the indicators may point toward the printer component adapted to be manipulated by a user it is associated with, in the illustrated case of FIG. 3C, latch 25. Such a directional indicator may be manufactured by masking an indicator using an optically opaque material, for example. Of course, other techniques may be used as well. Such directional spatial indicators provide enhanced spatial indication as compared to square indicators, for example, and are particularly well suited for use where several user manipulable components are located within close proximity to one another.

According to an embodiment of the present invention, one or more of the indicators may be positioned to provide light in an otherwise dark area inside housing 12 of printer 10. This may assist a user to find a piece of jammed media in these otherwise dark areas, thus further assisting a user with jam resolution. One such area is near drum 28 (FIG. 2), for example.

A processor 40 (shown schematically in FIG. 3B) is operatively coupled to sensors 36 and indicators 38. Processor 40 can either be contained within printer 10 or incorporated into a computer or other drive associated with the printer 10. Processor 40 is programmed to selectively and sequentially activate ones of the indicators 38 responsively to a media jam being detected by at least one of the sensors 36 and according to a determined resolution procedure. “Processor”, as used herein, refers generally to a computing device including a Central Processing Unit (CPU), such as a microprocessor. A CPU generally includes an arithmetic logic unit (ALU), which performs arithmetic and logical operations, and a control unit, which extracts instructions (e.g., a computer program incorporating code) from memory and decodes and executes the instructions, calling on the ALU when necessary.

Spatial indicators 38 are sequentially activated to help the user identify the location of jammed media. An exemplary resolution procedure associated with a media jam in a feed area of media path 26 is shown in FIGS. 3A and 3B. Once a sensor 36 detects a media jam in the feed area of the paper path 26, processor 40 determines a resolution sequence and activates spatial indicator 38 on the lower side access door 24 adjacent latch 25. This spatially indicates to a user that the first step to be taken is to open the side access door 24 using the latch 25. Once processor 40 detects side access door 24 has been opened (via a door 24 status sensor not-shown) processor 40 then activates a second indicator 38 adjacent the jammed media 35. In this manner, the sequential activation of indicators 38 spatially reflects the steps in the determined resolution sequence to be taken to locate the media jam in media path 26. Once the media jam has been cleared, sensor 36 detects the absence of the jammed media 35. Processor 40, then deactivates each activated indicator 38. For example, the activated indicators may be de-activated once the device is returned to operating condition (e.g., all doors are closed).

An exemplary resolution sequence associated with a media jam in the drum area of media path 26 is shown in FIGS. 4A-4C. A sensor 36 detects the presence of a media jam in the drum area of media path 26. Responsively thereto, processor 40 selectively activates at least one of spatial indicators 38 associated with the location of the detected media jam. In the illustrated case, an indicator 38 adjacent the top access door latch 21 is activated. Upon opening of the latch 21 by a user, processor 40 activates a next indicator 38 in the determined resolution sequence—indicator 38 adjacent toner cartridge 42 in the illustrated case. Upon removal of toner cartridge 42, a next indicator in the sequence is activated—indicator 38 adjacent the location of the jammed media 35 in the illustrated case. Once the media jam has been cleared, a sensor 36 detects the absence of the jammed media 35. Processor 40, in-turn, deactivates any indicators still activated.

According to an embodiment of the present invention, indicators 38 may be deactivated as a successive indicator is activated. Alternatively, once the sensor 36 has detected the location of the media jam and processor 40 has determined a resolution sequence, processor 40 can activate each indicator 38 associated with the determined resolution sequence at one time. However, in such a case a sequence of spatial indications is still provided as a user progresses through the determined resolution sequence.

Accordingly, sequential spatial-type guidance in provided by indicators 38 to help a user more precisely locate media jams that have occurred. The indicators 38 themselves indicate the successive steps to locate the media jam. The indicators 38 themselves indicate which printer component is to be next manipulated to clear the media jam. Additionally, indicators 38 in the vicinity of and preferably adjacent the media path 26, indicate the location of the jammed media 35. This allows a user to quickly identify the location of the media jam and clear it. It further aids the user in detecting multiple media jams.

### Visual Instruction

Referring again to FIG. 1, printer 10 has at least one user interface 46. In the illustrated embodiment of FIG. 1, user interface 46 takes the form of a control panel. According to an embodiment of the present invention, interface 46 has a visual display 47 that is arranged to reproduce images of users manipulating printer 10, e.g., such as by playing back motion including video. In an embodiment of the present invention, this visual instruction supports the spatial indicators discussed above and assists users to clear jams in accordance with a determined resolution sequence.

According to an embodiment of the present invention, processors configured to initiate a sequence of videos indicative of a multi-step resolution responsive to a sensed printable media jam. Video clips illustrating user operations are presented using display 47. Display 47 can take various forms of display apparatus, such as liquid crystal or gas discharge display panels, a micro display or a cathode-ray tube (CRT) display. Video clips may be spooled from an associated memory and/or are streamed or downloaded from a remote memory. For purposes of non-limiting explanation, “spooling” as used herein generally refers to buffering, such as by putting video clips in a video buffer, memory or on a disk where they can be accessed and played out from. And, “streaming” as used herein generally refers to a technique for transferring data such that it can be processed as a steady and continuous stream. With streaming, the beginning of a selected video clip may be played out before the entire clip is ready to be played.

Video playback via display 47 occurs when a jam is detected by one or more sensors 36. According to an embodiment of the present invention, a sequence of videos each associated with the determined resolution process is played back. In an embodiment of the present invention, each video played back is also associated with, and illustrates user interaction with, a printer 10 component associated with a then activated spatial indicator 38. For example, in the illustrated case of FIG. 3A, a video clip showing a user finding and manipulating latch 25 may be displayed. Accordingly, video instruction via display 47 supports one or more spatial indicators 38 identified as being associated with a determined jam resolution and that are then being activated by processor 40.

The playback can have selectable levels of detail, e.g., present different levels of detail for a novice user versus a moderately-proficient user, a very experienced user, or even a maintenance technician. Moreover, processor 40 can be programmed to determine the level of detail to be displayed, based upon sensed conditions and/or user selections via interface 46. Thus, processor 40 can be arranged to default to a summary clip with the programmed expectation that the summary will be sufficient, but later display a more detailed clip if the expected operation does not commence promptly or if user action does not proceed according to an expected sequence of user actions.

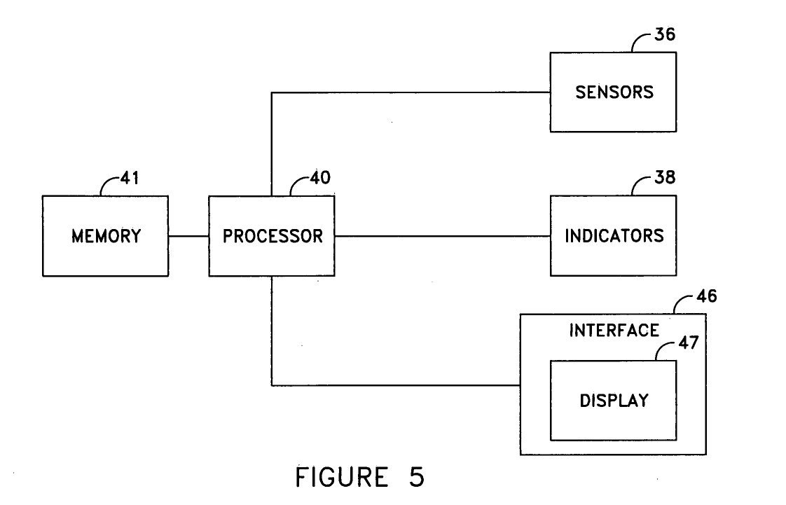

Referring now to the block diagram of FIG. 5, processor 40 detects a sensor 36 sensed jam condition. Responsively thereto, processor 40 can access memory 41 and determine a resolution sequence. As set forth above, processor 40 then activates one or more indicators 38 responsively to the determined resolution sequence. Processor 40 also selects a sequence of video clips to be displayed. The selected video clips may be spooled or streamed from a memory 41. “Memory”, as used herein, refers generally to one or more devices capable of storing data, such as in the form of chips, tapes, disks or drives. Memory may take the form of one or more random-access memory (RAM), read-only memory (ROM), programmable read-only memory (PROM), erasable programmable read-only memory (EPROM), or electrically erasable programmable read-only memory (EEPROM) chips, by way of example only. Memory may take the form of a hard disk or a CD-ROM, by way of further example. Memory may be internal or external to an integrated unit, e.g. an integrated circuit (IC), including processor 40.

According to an embodiment of the invention, memory 41 may be internal and/or external to printer 10 housing 12 (FIG. 1). Where memory 12 is external to printer 10, it may be take the form of the same sort of hardware and software elements that are used in general purpose computers, such as a computer being operatively coupled to printer 10 via a network. The printer 10 connection to the network can take the form of printer 10 and its processor 40 being addressable units on a local area network (LAN) and/or could involve a Transport Control Protocol/Internet Protocol (TCP/IP) data communication path, for example. For example, printer 10 may be coupled directly or indirectly to a network accessible to the global interconnection of computers and computer networks commonly referred to as the Internet, such that processor 40 has TCP/IP access. Accordingly, processor 40 may access ftp (file transfer protocol) directories maintained by the printer manufacturer or by a service or an interest group. These files can represent stored video clips. In such a case the ftp directories may embody memory 41. Alternatively, the data communication path may be to a remote Internet site that maintains streaming video programs that can be accessed for playback. In such a case the Internet site's memory may be used as memory 41. Streaming from a remote memory 41 may prove particularly appropriate for clips that are selected for presentation infrequently as compared to other clips. Alternatively, one or more video files can be downloaded and stored in printer 10 local memory 41, or a memory 41 housed in a computer operatively coupled to the printer 10.

In an embodiment of the present invention, each of the video clips contains a demonstration of at least one operation being performed on an exemplary device that at least resembles the subject printer 10. Further, the video clips may demonstrate one or more indicators 38 being activated, as are then occurring on the subject printer 10. The selection of video clips to be played can be made automatically by processor 40 and queued to the display 47, where display 47 includes a video processor. Alternatively, information indicative of the sensor 36 sensed jam(s) may be provided to a general purpose computer operatively coupled to the printer 10, which then sequentially selects and spools or streams videos to display 47. The selection may be based not only on which indicators 38 are then activated, but may also be based on the status of the apparatus as determined by various inputs to processor 40. These inputs may be indicative of the physical parts of printer 10, such as doors being ajar and user selections via interface 46. For example, the user can have the capability to select a programmed level of detail as desired, using interface 46.

The video clips may themselves be of any length and data rate or file size, but in an embodiment of the invention are short and to the point, containing demonstrations of actual operations being conducted on the same sort of device as printer 10. One or more of the video clips may take the form of full-motion video programs streamed from a source or decompressed from a moving pictures experts group (MPEG), audio video internet (AVI), movie or video file (MOV) or other media format source. One or more of the video clips may take the form of several graphics interchange format (GIF) still images in a series of steps. These can be played back, and/or looped, at a sufficiently fast pace as a brief animation. Other formats may be employed.

Relatively simpler clips can be combined or toggle selectable with more realistic, elaborate, detailed or lengthy illustrations. A simple depiction could show a cartoon animation, or a motion picture clip showing all or part of an artificially generated image. At least certain types of illustrations, such as close-ups, advantageously can contain less than a full body image. For hand and finger manipulated printer components, at least an appendage of an exemplary user can be shown in the depicted video, in an act of performing the operation next indicated by the determined resolution sequence, for example.

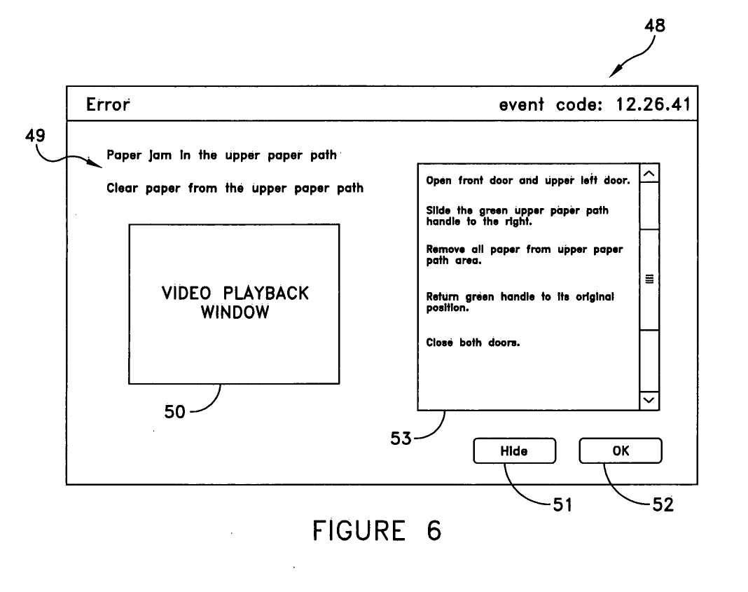

Referring now also to FIG. 6, there is shown an exemplary screen 48 that may be presented on display 47 (FIG. 1). In the illustrated case screen 48 includes a video playback area or window 50. Window 50 may take various shapes and sizes, such as being larger or smaller than in the illustrated embodiment. Buttons 51 and 52, in addition to or in lieu of other user interface elements (such as are part of interface 46 of FIG. 1), may be used to change, display or hide other elements of screen 48, such as text instruction window 53. For example, button 51 may be used to selectively hide or display window 53. Button 52 may be used to advance text window 53 to display different textual content. According to an embodiment of the present invention, the size or configuration of window 50 may be altered depending upon whether other display element(s), such as window 53, are then being displayed. By way of further example, when text window 53 is hidden, the size of window 50 may automatically be enlarged to represent a greater portion of display 48.

### Linguistic Instruction

Additionally, text-based instruction may be provided either on display 47 (FIG. 1) or another display on or operatively coupled to printer 10 to support the spatial indications. The text may take the form of instructive strings advising the user as to the next step in the determined resolution sequence. Text based instruction provision will be further discussed as it augments the spatial indicators, and determined resolution sequence, discussed with regard to FIGS. 3A and 3B for non-limiting purposes of explanation only. When a sensor 36 detects a media jam in the feed area of the paper path 26, processor 40 activates an indicator 38 on the lower side access door 24 adjacent latch 25. This spatially indicates to a user that the first step to be taken is to open the side access door 24 using latch 25. The first text string presented to the user may be indicative of this resolution step, such as “Open the lower side access door on the right-side of the printer”, or “Open the lower side access door as is shown in the video”, or “Open the lower side access door next to the blinking arrow.” The text strings may be stored in memory 41 (FIG. 5) and selected in an analogous manner as video clips are selected.

Referring again to FIG. 6, screen 48 includes text based content 49 and text based window 53. In the illustrated case, text 49 provides an indication of the type of error that has been detected, and a summary of the corrective action that has been specified by the determined resolution sequence. Window 53 content provides instructive strings advising the user as to the steps in the determined resolution sequence.

### Audible Alerts

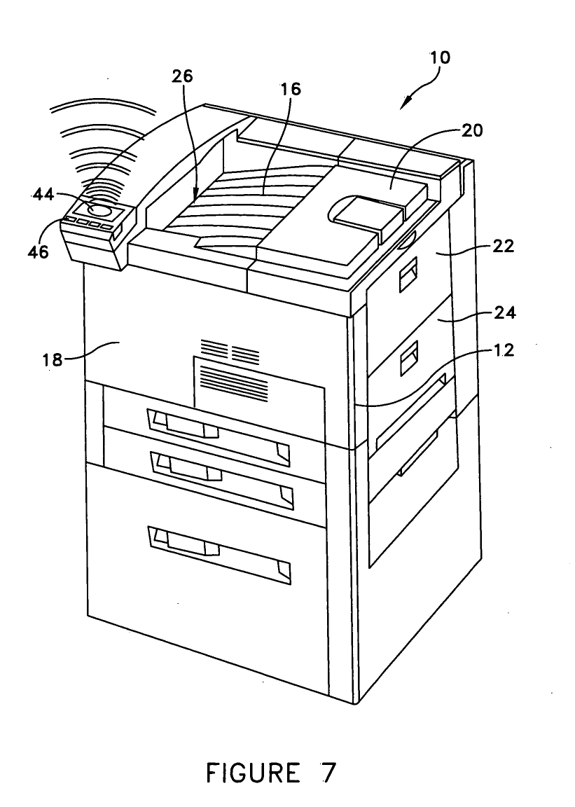

Audible instruction may be used to support the spatial indications. According to an embodiment of the present invention, two or more types of audible alerts may be provided responsively to user manipulation of parts of a printing device as audible instructions. Referring now to FIG. 7, the audible alerts can be provided by a speaker 44 integrated into the printing device 10, such as interface 46 and/or integrated with a computer communicatively coupled to the printing device. According to an embodiment of the present invention, processor 40 selectively triggers the audible alerts responsively to user interaction with user operable components of printer 10.

The audible alerts will be further discussed as they augment the spatial indicators, and sequential resolution, discussed with regard to FIGS. 3A and 3B for non-limiting purposes of explanation only. Again, when a sensor 36 detects a media jam in the feed area of the paper path 26, processor 40 activates an indicator 38 on the lower side access door 24 adjacent latch 25. This spatially indicates to a user that the first step to be taken is to open the side access door 24 using latch 25. Once the processor detects side access door 24 has been opened, processor 40 then causes a first audible alert to be sounded and activates a second spatial indicator 38 adjacent the jammed media 35. If a user manipulable printer 10 component other than side access door 24 is determined to be manipulated by the user, e.g., the top access door latch 21 is opened, a second audible alert, distinct from the first audible alert is sounded. Once the media jam has been cleared, sensor 36 detects the absence of the jammed media 35. Responsively thereto, processor 40 triggers another generally positive feedback audible alert.

According to an embodiment of the present invention, the first audible signal provides generally positive feedback, e.g., is a generally pleasant sound like a ding, ta-da or the like. While the second audible signal provides generally negative feedback, e.g., is a generally unpleasant sound like a buzz, for example. Thus, when a user manipulates the printer component next specified by the jam resolution sequence positive feedback is provided. And, when a user manipulates a printer component other than that next specified by the jam resolution sequence negative reinforcement is provided.

Alternatively, or in addition thereto, the audible indication(s) may also correspond to the instructions provided in window 53, such as by essentially announcing the textual strings to a user.

Accordingly, audible indications indicative of a determined resolution sequence for a detected jam are provided. And, the sequential activation of audible indications audibly reflects user compliance with the determined resolution sequence for locating and clearing the media jam in media path 26.

### Resolution Sequence Determination and Implementation

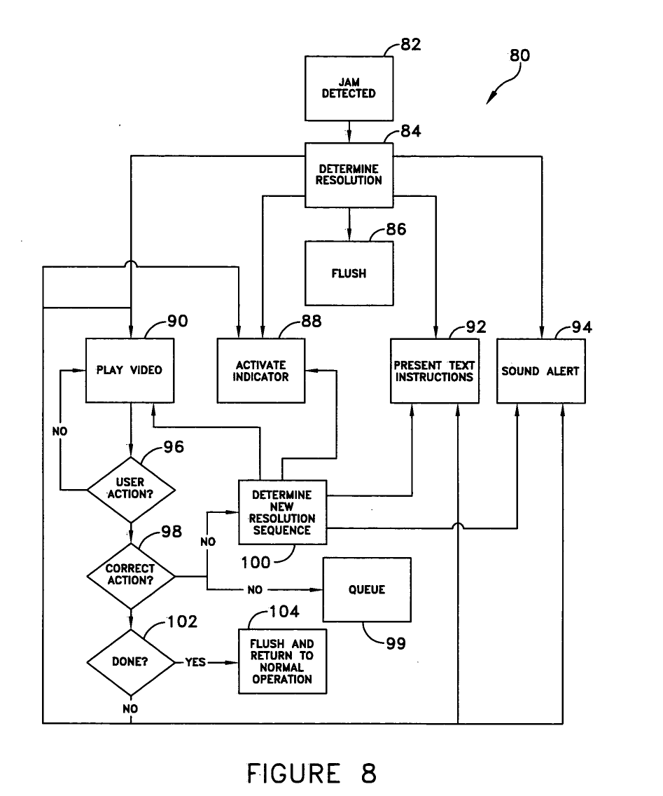

Sensors 36 detect media as it progresses along media path 26. Timing may be used to establish when media is expected to be delivered from one portion to another portion of path 26. Sensors 36 may detect this delivery. When media is not delivered as expected, a jam condition may be determined to exist, such as by processor 40. Referring now to FIG. 8, there is shown a resolution sequence or process 80. Process 80 commences with a jam being detected at block 82. At block 84, a resolution sequence or procedure is determined. Accordingly, an embodiment of the present invention, the determined resolution sequence or procedure is used to direct the spatial indicators, visual instruction and text based instruction; e.g., is commonly used by these different types of instruction. The resolution sequence may be determined by processor 40 or a general purpose computer operatively coupled to processor 40. Alternatively, where the printer 10 is coupled directly or indirectly to a network accessible to the worldwide web (the Internet) and processor 40 has TCP/IP access to one or more servers maintained by the printer manufacturer or by a service or an interest group, the jam indication may be provided to a server, and the resolution sequence provided thereby to the processor 40. “Server”, as used herein, generally refers to a computing device, connected to a network and that manages network resources. A server may be a dedicated collection of computing hardware and/or software components, meaning that they perform no other tasks besides their server tasks, or may refer to hardware and/or software components that are managing resources rather than the entire computing device. A server generally includes, and/or uses, a processor.

The resolution sequence or process may be determined by identifying which sensor(s) a detected jam is associated with, and identifying a predefined resolution sequence or process associated with the identified sensor(s). For example, in the illustrated case of FIG. 2, there are five sensors 36. A resolution sequence for each of the five sensors may be stored, such as within memory 41 (FIG. 5). Upon detecting a jam associated with one of the five sensors, the corresponding resolution sequence may be determined and recovered from memory 41 by processor 40.

Responsively thereto, media in path 26 downstream from the detected jam is flushed to the finisher or output tray at block 86, e.g., out of path 26. At block 88 a spatial indicator 38 (FIG. 1) associated with a first step in the determined resolution sequence is activated. At block 90, a first video clip associated with the first step in the determined resolution sequence is played out. At block 92 textual instructions associated with the determined resolution sequence are presented. At block 94, an audible alert associated with the determined resolution sequence is sounded. According to an embodiment of the present invention, the played video clip shows a user finding the activated spatial indicator and manipulating the printer 10 component associated with the activated indicator in accordance with the presented text instructions. At block 96, it is determined whether a user has yet manipulated a printer 10 component. According to an embodiment of the present invention, the played video clip may be looped until a user interacts with printer 10, such as by opening a door thereof.

When a user manipulation of a printer 10 component is sensed, e.g., a printer 10 door is opened, it is determined whether the correct user manipulable component, e.g., the component associated with the activated spatial indicator, has been manipulated at block 98. If it is determined that an improper action was taken at block 98, the resulting condition can be queued as a separate jam for analogous resolution, either before or after prior jam(s) are cleared at block 99. In such a case, printer components that were improperly manipulated by the user may be tracked. After the jam has been cleared, the user may be prompted (via processing analogous to that described with regard to blocks 88, 90, 92, 94, 96, 98) to remove any media pages in the printer 10 areas improperly accessed.

Alternatively, if it is determined at block 98 that the correct action was not taken, the resolution sequence may be updated to remedy or reverse the incorrect action taken by the user at block 100. This may involve processor 40 looking up a resolution sequence for reversing the incorrect action and inserting the steps of that sequence prior to the steps of the sequence determined at block 84. Responsively thereto, the video clip, activated indicators, text instructions and sound alerts at blocks 88, 90, 92 and 94 are all updated. For example, at block 88, a clip of a user reversing the incorrect action may be retrieved and played out. At block 90, an indicator associated with an incorrectly manipulated component may be activated. At block 92, the textual instructions may be updated to reverse the incorrect action. And, at block 94 a negative reinforcement tone may be sounded to indicate an incorrect action was taken. The new resolution sequence determined at block 100 may include clearing media pages in areas of printer 10 improperly accessed and reverse manipulating the printer 10 component improperly manipulated by the user.

Where a correct user action is determined to have taken place at block 98, it is determined whether there are any more steps to be taken in the determined resolution at block 102. If there are no additional steps, media pages upstream from the sensed jam are flushed through path 26 to the finisher or bin and printer 10 returns to normal operation at block 104. For example, a pending job may be recalculated back to the last good page, e.g., the last page before the jam, such that job processing may continue.

If there are additional steps to be taken in the determined resolution, the next step in the determined resolution is used and processing returns to blocks 88, 90, 92, 94, where a next video is played, a next indicator is activated, the instruction text may be updated, or automatically scrolled through, and another available indicator may be sounded.

According to an embodiment of the invention, the blocks are iteratively repeated until the jam has been cleared and all user manipulated components have been returned to their normal operating state or condition. In this way, a user is guided through clearing a jam and provided with positive and negative feedback regarding their actions as taken.

In some instances, a media jam may occur at more than one location along media path 26. When this occurs, multiple sensors 36 detect media jams at multiple locations. According to an embodiment of the present invention, in such a case processor 40 operates to clear a first of the media jams, and upon clearing of the first media jam, to clear any successive media jams. Once all media jams have been cleared all indicators may be de-activated.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A printing device comprising:
a media path for moving printable media through the device;
a plurality of printable media jam sensors associated with the media path;
a plurality of indicators; and
a processor operatively coupled to the sensors and indicators, and configured to:
initiate a sequence of text-based instructions indicative of a multi-step resolution and responsively to a sensed printable media jam;
initiate a sequence of videos indicative of the steps of the multi-step resolution; and,
sequentially activate ones of the visual indicators associated with the resolution steps of the multi-step resolution.

2. The device of claim 1, further comprising a plurality of user-operable components each associated with the media path; wherein each of the indicators is associated with a corresponding one of the components.

3. The device of claim 2, wherein the processor is further operable to:
sense user manipulation of at least one of the components;
sound a first audible alert when the manipulated component is associated with an activated one of said indicators; and,
sound a second audible alert when the manipulated component is associated with an activated one of said indicators.

4. The device of claim 2, wherein each of the indicators points to the corresponding one of the components.

5. The device of claim 1, wherein the processor is further operative to retrieve a plurality of files associated with the videos via a network.

6. The device of claim 1, wherein the processor is further operative to determine the multi-step resolution responsively to a sensed printable media jam.

7. The device of claim 1, wherein each indicator comprises at least one light emitting diode.

8. The device of claim 1, further comprising at least one light emitting device positioned to provide light in an otherwise dark area of the printing device responsively to a sensed printable media jam.

9. A method for assisting a user to clear a media jam in a printing device, comprising:
providing text-based instructions responsively to detecting the media jam;
providing video-based instructions responsively to detecting the media jam; and,
activating visible indicators corresponding to select parts of the printing device responsively to detecting the media jam;
wherein the text based instructions, video-based instructions and activating each communicate a common resolution procedure for the detected media jam.

10. The method of claim 9, wherein:
the printing device comprises a plurality of components; and
the common resolution procedure comprises a sequence of actions each associated with at least one of the components.

11. The method of claim 10, further comprising:
identifying a first of the components associated with the common resolution procedure;
activating at least one of the visual indicators corresponding to the first component; and
initiating at least a first video showing the first indicator and first component.

12. The method of claim 11, further comprising:
identifying at least a second of the components associated with the common resolution procedure;
activating at a second of the indicators corresponding to the second component responsively to user manipulation of the first component; and,
initiating at least a second video showing the second indicator and second component.

13. The method of claim 10, further comprising:
identifying ones of the components associated with the common resolution procedure; and,
sequentially and iteratively, activating ones of the indicators corresponding to the identified components;
initiating text-based instruction referencing the identified components; and,
initiating videos showing the activated indicators and ones of the components.

14. The method of claim 13, further comprising:
sensing user manipulation of one of the components;
sounding a first audible alert when the manipulated components are identified ones of the components associated with the common resolution procedure; and,
sounding a second audible alert when the manipulated components are not identified ones of the components associated with the common resolution.

15. The method of claim 13, wherein the first audible alert provides positive user feedback.

16. The method of claim 15, wherein the first audible alert is a ding.

17. The method of claim 15, wherein the second audible alert provides negative user feedback.

18. The method of claim 17, wherein the second audible alert is a buzz.
